(19) United States
(12) Patent Application Publication
(10) Pub. No.: US 2014/0075685 A1
(43) Pub. Date: Mar. 20, 2014

(54) FABRIC CARE COMPOSITION

(71) Applicant: The Procter & Gamble Company, Cincinnati, OH (US)

(72) Inventors: Pieter Jan Maria Saveyn, Heusden (BE); Hugo Jean Marie Demeyere, Merchtem (BE)

(73) Assignee: The Procter & Gamble Company, Cincinnati, OH (US)

(21) Appl. No.: 14/025,855

(22) Filed: Sep. 13, 2013

(30) Foreign Application Priority Data
Sep. 14, 2012 (EP) 12184483.1
Jul. 17, 2013 (EP) 13176784.0

(51) Int. Cl. C11D 3/00

(52) U.S. Cl. CPC C11D 3/0026
USPC 8/137; 510/276; 510/107; 510/102; 510/101

(57) ABSTRACT

An aqueous fabric care composition used to provide in wear comfort and avoiding a sweat smell on the fabric. The composition comprises from 0 wt % to 5 wt % of anionic surfactant, from 0 wt % to 3 wt % of cationic surfactant, from 0.05 wt % to 3 wt % of a non-ionic surfactant, from 0.01 wt % to 15 wt % of a suds suppressor technology, perfume.

### FIELD OF THE INVENTION

The present invention relates to the field of aqueous fabric care compositions, in particular fabric care compositions to rinse the fabrics after they have been washed, such compositions being efficient at fighting the in-wear disagreements of sweating, such as humidity of the fabric and malodour of the fabric.

### BACKGROUND OF THE INVENTION

Fabrics are typically washed with a detergent composition comprising anionic surfactant. During the rinsing step, the presence of remaining anionic surfactant leads to sudsing and to an ineffective rinsing of the fabrics. Rinsing compositions typically comprise cationic surfactants. It is believed that the cationic surfactant helps to reduce foam by complexing with anionic surfactant. As such, the cationic surfactant is typically seen as an essential ingredient, or even the key ingredient, for a rinsing composition.

However, the inventors have surprisingly found that the fabric care compositions comprising cationic surfactant are not always satisfying. The inventors have discovered that fabrics which have been in contact with such compositions are not comfortable to wear. The sweat of the person wearing the fabric may not properly evaporate. This leads to a discomfort of the wearer who may feel the humidity and the unpleasant smell of sweat. This is particularly true when the fabric is worn in a hot environment.

There is thus a need to provide fabric care compositions, in particular rinsing compositions, which provide to the rinsed fabric more in-wear pleasant properties, such as a better smell and feeling even when the wearer is sweating.

### SUMMARY OF THE INVENTION

According to the present invention, there is provided an aqueous fabric care composition, preferably a rinsing composition, comprising:
a. from 0 wt % to 5 wt % of anionic surfactant,
b. from 0 wt % to 3 wt % of cationic surfactant,
c. from 0.05 wt % to 3 wt % of a non-ionic surfactant,
d. from 0.01 wt % to 15 wt % of a suds suppressor technology,
e. perfume.

The inventors have found that the fabric care composition of the invention are not only providing good rinsing properties, but are also particularly effective at providing a nice smell to the fabric and avoiding a smell of sweat to develop on the fabric when worn. The fabrics rinsed with the fabric care compositions of the invention may be more comfortable to wear, in particular because the sweat can evaporate more easily. The fabric care composition may be more stable to changes of temperature.

The aqueous fabric care composition may comprises from 0 wt % to 1.5 wt % of anionic surfactant, from 0 wt % to 1.5 wt % of cationic surfactant, from 0.1 wt % to 2 wt % of a non-ionic surfactant, from 0.02 wt % to 2 wt % of a suds suppressor technology which is a polymeric silicone, and from 45 wt % to 99 wt % of water.

The invention also concerns the use of an aqueous fabric care composition according to the invention to reduce the sweat smell of fabrics when they are worn and/or to improve the comfort of wearing fabric in a hot environment and/or to reduce the visible signal of sweating. A visible signal of sweating is for example the sweat patch that typically appears around the arm pit.

### BRIEF DESCRIPTION OF THE DRAWINGS

FIG. 1 shows the sweat evaporation profile of a fabric rinsed with a composition of the invention (composition 1A of Example 1) compared with the sweat evaporation profile of a fabric rinsed with a comparative composition (composition 1B of example 1) as measured according to the protocol of example 2. The percentage of evaporation is higher with the composition of the invention.

FIG. 2 shows the isovaleric acid headspace concentration of a fabric rinsed with a composition of the invention (composition 1A of Example 1) and of a fabric rinsed with a comparative composition (composition 1B of example 1) as measured with the protocol of example 3. The isovaleric acid headspace is lower for the fabric rinsed with the composition 1A than for the fabric rinsed with composition 1B.

### DETAILED DESCRIPTION OF THE INVENTION

All percentages, ratios and proportions used herein are by weight percent of the composition, unless otherwise specified. All average values are calculated “by weight” of the composition or components thereof, unless otherwise expressly indicated.

### The Aqueous Fabric Care Composition

The aqueous fabric care composition comprises water, preferably at least 10%, in particular at least 30%, or 40%, or 50%, or 60%, or 70%, or 80%, or 90% by weight of water. The composition may comprise from 45% to 99% or from 65% to 98% by weight of water.

The composition is preferably in liquid form. The composition is preferably a rinse-added composition.

The invention also concerns a package comprising the composition of the invention. The package may not comprise a spraying system.

The composition may be comprised in a packaged comprising from 1 ml to 3 l of product, for example from 2 ml to 1 l or from 3 ml to 500 ml or from 5 ml to 100 ml or from 7 ml to 50 ml or from 10 ml to 20 ml.

The package may be a bottle or a sachet. The package may comprise plastic such as polyolefins, polyesters, polyamides, vinyl, polyvinylchloride, acrylic, polycarbonates, polystyrene, and polyurethane. Plastics can include both thermoplastic and/or thermoset. The plastic bottle may comprise PET and/or may comprise from 100 ml to 1.5 l of product, preferably from 300 ml to 1 l. The sachet may comprise from 5 ml to 30 ml of product, preferably from 10 ml to 20 ml.

### The Surfactant System

Anionic Surfactant

It is preferable that the composition does not comprise or comprises a limited amount of anionic surfactant. Compositions comprising no or a low level of anionic surfactant have better rinsing properties. The composition comprises from 0% to 5% by weight of anionic surfactant. Preferably the composition comprises less than 3%, or even less than 1%, or even less than 0.5%, or 0.2%, or 0.1% by weight of anionic surfactant. Preferably, the composition is free or essentially free of anionic surfactants.

The composition may comprise less than 3%, or even less than 1%, or even less than 0.5%, or 0.2%, or 0.1% by weight or may be essentially free of alkyl benzene sulfonic acids and their salts, alkoxylated or non-alkoxylated alkyl sulfate materials, ethoxylated alkyl sulfate surfactants, mid-branched primary alkyl sulfate surfactants, and mixtures thereof.

Cationic Surfactant

It is preferable that the composition of the invention comprises no cationic surfactant or a limited amount of cationic surfactant. The composition comprises from 0% to 3% by weight of cationic surfactant. Preferably the composition comprises less than 2%, or even less than 1% or even less than 0.5%, or less than 0.2%, or less than 0.1% by weight of cationic surfactant. Preferably, the composition is free or essentially free of cationic surfactants.

Cationic surfactants include but are not limited to, quaternary ammonium compounds. Quaternary ammonium compounds may comprise ester quats, amide quats, imidazoline quats, alkyl quats, amdioester quats, and mixtures thereof. Quaternary ammonium compounds may comprise monoalkyquaternary ammonium compound, dialkylquaternary ammonium compound, trialkylquaternary ammonium compound, a diamido quaternary compound, a diester quaternary ammonium compound. Preferably, the composition comprises less than 2.5% by weight, or even less than 1% or even less than 0.5%, or 0.2%, or 0.1% of quaternary ammonium compounds.

Ester quaternary ammonium compounds include, but are not limited to, compounds selected from the group consisting of mono esters of acyl-oxyethyl-N,N-dimethylammonium chloride, diesters of acyl-oxyethyl-N,N-dimethylammonium chloride, trimester quats, and mixtures thereof. Amide quats include but are not limited to, materials selected from the group consisting of monoamide quats, diamide quats and mixtures thereof. Alkyl quats include but are not limited to, materials selected from the group consisting of mono alkyl quats, dialkyl quats quats, trialkyl quats, tetraalkyl quats and mixtures thereof.

Other examples of cationic surfactant include, but are not limited to, N,N-bis(stearoyl-oxy-ethyl) N,N-dimethyl ammonium chloride, N,N-bis(tallowoyl-oxy-ethyl) N,N-dimethyl ammonium chloride, N,N-bis(stearoyl-oxy-ethyl) N-(2 hydroxyethyl) N-methyl ammonium methylsulfate, 1, 2 di (stearoyl-oxy) 3 trimethyl ammoniumpropane chloride, dialkylenedimethylammonium salts such as dicanoladimethylammonium chloride, di(hard)tallowedimethylammonium chloride, dicanoladimethylammonium methylsulfate, dioleyldimethylammonium chloride available from Witco Corporation under the trade name Adogen® 472, dihardtallow dimethylammonium chloride available from Akzo Nobel Arquad 2HT75, 1-methyl-1-stearoylamidoethyl-2-stearoylimidazolinium methylsulfate available commercially from the Witco Corporation under the trade name Varisoft®, 1-tallowylamidoethyl-2-tallowylimidazoline, ditallowoyloxyethyl dimethyl ammonium chloride, dihydrogenated-tallowoyloxyethyl dimethyl ammonium chloride, ditallow dimethyl ammonium chloride, alkylbenzenedimethyl ammonium chloride, dihydrogenatedtallow dimethyl ammonium chloride, ditallowoyloxyethyl methylhydroxyethylammonium methyl sulfate, dihydrogenated-tallowoyloxyethyl methyl hydroxyethylammonium chloride.

Nonionic Surfactant

The composition of the invention comprises from 0.05% to 3% by weight of nonionic surfactant. Preferably, the composition comprises from 0.1% to 2.5% by weight of nonionic surfactant. The composition may comprise from 0.2% to 2% or from 0.4% to 1.5% or from 0.5% to 1% by weight of nonionic surfactant.

Nonionic surfactants, includes alkoxylated fatty alcohols, amine oxide surfactants, sorbitan esters and their derivatives, and mixtures thereof. Preferably, the nonionic surfactant is liquid at 25° C.

Alkoxylated fatty alcohols are materials which correspond to the general formula: R₁(CₘH₂ₘO)ₙOH wherein R₁ is a C₈-C₁₆ alkyl group, m is from 2 to 4, and n ranges from about 2 to 12. Preferably R₁ is an alkyl group, which may be primary or secondary, that contains from about 9 to 15 carbon atoms, more preferably from about 10 to 14 carbon atoms. In one embodiment, the alkoxylated fatty alcohols will also be ethoxylated materials that contain from about 2 to 12 ethylene oxide moieties per molecule, more preferably from about 3 to 10 ethylene oxide moieties per molecule.

Alkoxylated fatty alcohol nonionic surfactants have been marketed under the tradename NEODOL® by the Shell Chemical Company.

Amine oxides are materials which are often referred to in the art as “semi-polar” nonionics. Amine oxides have the formula: R₂(EO)ₓ(PO)_{y}(BO)_{z}N(O)(CH₂R₃)₂.qH₂O. In this formula, R₂ is a relatively long-chain hydrocarbyl moiety which can be saturated or unsaturated, linear or branched, and can contain from 8 to 20, preferably from 10 to 16 carbon atoms, and is more preferably C₁₂-C₁₆ primary alkyl. R₃ is a short-chain moiety, preferably selected from hydrogen, methyl and —CH₂OH. When x+y+z is different from 0, EO is ethyleneoxy, PO is propyleneneoxy and BO is butyleneoxy. Amine oxide surfactants are illustrated by C₁₂-C₁₄ alkyldimethyl amine oxide.

Sorbitan esters are esterified dehydration products of sorbitol. The preferred sorbitan ester comprises a member selected from the group consisting of C₁₀-C₂₆ acyl sorbitan monoesters and C₁₀-C₂₆ acyl sorbitan diesters and ethoxylates of said esters wherein one or more of the unesterified hydroxyl groups in said esters preferably contain from 1 to about 6 oxyethylene units, and mixtures thereof. For the purpose of the present invention, sorbitan esters containing unsaturation (e.g., sorbitan monooleate) can be utilized.

Details, including formula, of the preferred sorbitan esters can be found in U.S. Pat. No. 4,128,484.

Certain derivatives of the preferred sorbitan esters herein, especially the “lower” ethoxylates thereof (i.e., mono-, di-, and tri-esters wherein one or more of the unesterified —OH groups contain one to about twenty oxyethylene moieties are also useful in the composition of the present invention. Therefore, for purposes of the present invention, the term “sorbitan ester” includes such derivatives. An example of a preferred material is Polysobate 61 known as Tween® 61 from ICI America.

Other useful alkyl sorbitan esters for use in the softening compositions herein include sorbitan monolaurate, sorbitan monomyristate, sorbitan monopalmitate, sorbitan monobehenate, sorbitan monooleate, sorbitan dilaurate, sorbitan dimyristate, sorbitan dipalmitate, sorbitan distearate, sorbitan dibehenate, sorbitan dioleate, and mixtures thereof, and mixed tallowalkyl sorbitan mono- and di-esters. Such mixtures are readily prepared by reacting the foregoing hydroxy-substituted sorbitans, particularly the 1,4- and 1,5-sorbitans, with the corresponding acid, ester, or acid chloride in a simple esterification reaction.

Other preferred sorbitan esters are disclosed in U.S. Pat. No. 4,022,938.

The composition may comprise a non ionic surfactant comprising polyglycerol ester.

Non-limiting examples of nonionic surfactants include: a) C₁₂-C₁₈ alkyl ethoxylates, such as, NEODOL® nonionic surfactants; b) C₆-C₁₂ alkyl phenol alkoxylates wherein the alkoxylate units are a mixture of ethyleneoxy and propyleneoxy units; c) C₁₂-C₁₈ alcohol and C₆-C₁₂ alkyl phenol condensates with ethylene oxide/propylene oxide block polymers such as PLURONIC® from BASF; d) C₁₄-C₂₂ mid-chain branched alcohols, BA, as discussed in U.S. Pat. No. 6,150,322; e) C₁₄-C₂₂ mid-chain branched alkyl alkoxylates, BAEₓ wherein x is 1-30, as discussed in U.S. Pat. Nos. 6,153,577; 6,020,303; and 6,093,856; f) alkylpolysaccharides as discussed in U.S. Pat. No. 4,565,647; specifically alkylpolyglycosides as discussed in U.S. Pat. Nos. 4,483,780 and 4,483,779; g) polyhydroxy fatty acid amides as discussed in U.S. Pat. No. 5,332,528; WO 92/06162; WO 93/19146; U.S. Pat. No. 5,188,769; and U.S. Pat. No. 5,648,329; h) ether capped poly(oxyalkylated) alcohol surfactants as discussed in U.S. Pat. No. 6,482,994 and U.S. Pat. No. 6,844,309; i) ethoxylate of sorbitan esters.

Nonionic surfactants, includes the Abex series from Rhodia Inc., Actrafos series from Georgia Pacific, Acconon series from Abitec Corporation, Adsee series from Witco Corp., Aldo series from Lonza Inc., Amidex series from Chemron Corp., Amodox series from Stepan Company, heterocyclic type products, and many other companies. Preferred nonionic surfactants include tallow alkyl ethoxylate (such as Genapol T080 supplied by Clariant described in U.S. Pat. No. 5,670,476), and Surforic L24-7 from BASF.

The non-ionic surfactant may have an HLB value comprised between 10 and 19.5 or between 11 and 19 or between 12 and 18.5 or between 14 and 18.

Preferably, most of the surfactant in the composition is non-ionic. In the composition of the invention, the weight ratio of (Cationic surfactant+Anionic surfactant+Non-ionic surfactant) to (Non-ionic surfactant) is preferably below 10, preferably below 5, for example between 1 and 2, or between 1 and 1.5. or between 1 and 1.2 or between 1 and 1.1.

Zwitterionic surfactants and amphoteric surfactants which are substantially non-ionic at neutral pH may be considered as non-ionic surfactants for the purpose of the invention. Zwitterionic surfactants and amphoteric surfactants which are substantially cationic or anionic at neutral pH may respectively be considered as cationic or anionic surfactants for the purpose of the invention.

The composition of the invention may comprise no zwitterionic and/or amphoteric surfactant or a limited amount of such surfactant. The composition may comprise from 0% to 3% by weight of zwitterionic and/or amphoteric surfactant. The composition may comprise less than 2%, or even less than 1% or even less than 0.5%, or 0.2%, or 0.1% by weight of zwitterionic and/or amphoteric surfactant. The composition may be free or essentially free of zwitterionic and/or amphoteric surfactants.

### The Suds Suppressor Technology

The aqueous fabric care composition comprises a suds suppressor technology present at a level of from 0.01% to 15% by weight. Preferably the composition comprises at least 0.02%, or 0.05%, or even at least 0.1% by weight of a suds suppressor technology. The composition may comprise less than from 5%, or less than 3%, or even less than 1% by weight of a suds suppressor technology.

The suds suppressor technology may comprise any known antifoam compound, including highly crystalline waxes and/or hydrogenated fatty acids, silicones, silicone/silica mixtures, lower 2-alkyl alkanols, fatty acids, and mixtures thereof.

The lower 2-alkyl alkanol may be 2-methyl-butanol.

The fatty acid may be a C₁₂-C₁₈ saturated and/or unsaturated, linear and/or branched, fatty acid, and is preferably a mixture of such fatty acids. A preferred mixture of fatty acids is a mixtures of saturated and unsaturated fatty acids, for example a mixture of rape seed-derived fatty acid and C₁₆-C₁₈ topped whole cut fatty acids, or a mixture of rape seed-derived fatty acid and a tallow alcohol derived fatty acid, palmitic, oleic, fatty alkylsuccinic acids, and mixtures thereof. The fatty acids may be branched and of synthetic or natural origin, especially biodegradable branched types. Monocarboxylic fatty acids and soluble salts thereof, are described in U.S. Pat. No. 2,954,347.

Examples of silicones, and silica-silicone mixtures are disclosed in U.S. Pat. Nos. 5,707,950 and 5,728,671.

Examples of mixture of antifoam compounds are commercially available from companies such as Dow Corning.

Preferably, the suds suppressor technology comprises a silicone-based compound. Silicone based suds suppressor technology is described in (US 2003/0060390 A1, 65-77). Preferably, the composition comprises from 0.01 to 3% of a silicone-based compound. Less than 3% of a silicone based compound is typically enough to provide the desired rinsing properties. Preferably, the silicone based compound comprises polydimethylsiloxane. The silicone based antifoam compounds may comprise silica and siloxane, for example a polydimethylsiloxane having trimethylsilyl end blocking units. Examples of particulate suds suppressor technologies are described in EP-A-0210731. Examples of particulate suds suppressor technologies in particulate form are described in U.S. Pat. No. 4,806,266. The inventors have discovered that the suds suppressor technology comprising a silicone-based compound were particularly suitable in the aqueous fabric care composition of the invention.

The aqueous fabric care composition may have a weight ratio of (Suds suppressor technology) to (Non-ionic surfactant) between 0.02 and 8 or between 0.05 and 4 preferably between 0.1 and 2 or between 0.2 and 1.

The aqueous fabric care composition may have a weight ratio of (Suds suppressor technology) to (Non-ionic surfactant+Cationic surfactant+Anionic surfactant) between 0.02 and 8 or between 0.05 and 4 preferably between 0.1 and 2 or between 0.2 and 1.

The aqueous fabric care composition may have a weight ratio of (Suds suppressor technology) to (Suds suppressor technology+Cationic surfactant+Anionic surfactant) below 20, preferably below 10, for example between 1 and 3, or between 1 and 1.5 or between 1 and 1.2 or between 1 and 1.1.

The Perfume

The aqueous fabric care composition comprises a perfume.

The composition may comprise from 0.01% to 10%, or from 0.1% to 5%, or even from 0.2% to 2% by weight of a perfume composition. The composition may comprise at least 0.75% or at least 1% by weight of a perfume composition.

Preferably, the perfume comprises a mixture of at least 3, or even at least 5, or at least 7, or at least 10, or at least 15 perfume raw materials.

Preferably, the perfume composition comprises at least 50% per weight, in particular at least 60%, or at least 70%, or at least 80%, or at least 90%, for example from 65% to 100%, or from 95% to 99.9% per weight of perfume raw material selected from: Lavandin Grosso oil; Iso Propyl-2-Methyl Butyrate; Dimethyl cyclohexenyl 3-butenyl ketone; Eucalyptol; Benzyl Acetate; Hexyl Acetate; Methyl Benzoate; 3a,4,5,6,7,7a-hexahydro-4,7-methano-1H-indenyl acetate; Octanal; Cis-3 hexen-1-ol; Nonanal; Ethyl-2-methyl Butyrate; (Z,E)-2,4-dimethyl cyclohex-3-ene-1-carbaldehyde, Tetrahydro-4-methyl-2-(2-methyl propenyl)-2H-pyran; Geraniol; Iso propylbutanal; 2-pentylcyclopentan-1-ol; Dodecenal; d-limonene; Allyl Caproate; Decenal; Tetra Hydro Linalool; (E)-1-trimethyl-1-cyclohex-3 (2,6,6-enyl)but-2-en-1-one; 2,4,6-trimethyl-3-cyclohexene-1-carboxaldehyde; Ionone Beta; Prenyl Acetate; 3-(4-tert-butylphenyl)propanal; 1 Carvone; Allyl Cyclohexyl Propionate; Linalool; Phenyl ethyl alcohol; Lemon Oil; Eugenol; Ethyl Vanillin; Cis-3-Hexenyl Acetate; Diphenyl Oxyde; Ionone Alpha; prop-2-enyl 2-cyclohexyloxyacetate; 2-pentyl-Cyclopentanone; Ethyl-2-methyl Pentanoate; [(4Z)-1-cyclooct-4-enyl]methyl carbonate; Cedryl Acetate; Cinnamic Alcohol; 2-methoxyethylbenzene; Phenyl Ethyl Phenyl Acetate; Citronellol; 2-tert-butyl cyclohexyl acetate; Citral; 3alpha,4,5,6,7,7alpha-hexahydro-4,7-methano-1H-inden-6-ylpropanoate; Iso-bornyl iso-butyrate; and mixture thereof.

Preferably, the perfume composition comprises at least 50% per weight, in particular at least 60%, or at least 70%, or at least 80%, or at least 90%, for example from 65% to 100% per weight of perfume raw material selected from Lavandin Grosso oil; Iso Propyl-2-Methyl Butyrate; Dimethyl cyclohexenyl 3-butenyl ketone; Eucalyptol; Benzyl Acetate; Hexyl Acetate; Methyl Benzoate; 3a,4,5,6,7,7a-hexahydro-4,7-methano-1H-indenyl acetate; Octanal; Cis-3 hexen-1-ol; Nonanal; Ethyl-2-methyl Butyrate; (Z,E)-2,4-dimethyl cyclohex-3-ene-1-carbaldehyde, Tetrahydro-4-methyl-2-(2-methyl propenyl)-2H-pyran; Geraniol; Iso propylbutanal; 2-pentylcyclopentan-1-ol; Dodecenal; d-limonene; Allyl Caproate; Decenal; Tetra Hydro Linalool; (E)-1-trimethyl-1-cyclohex-3 (2,6,6-enyl)but-2-en-1-one; 2,4,6-trimethyl-3-cyclohexene-1-carboxaldehyde; Ionone Beta; Prenyl Acetate; 3-(4-tert-butylphenyl)propanal; 1 Carvone; Allyl Cyclohexyl Propionate; Linalool; Phenyl ethyl alcohol; Lemon Oil; Eugenol; Ethyl Vanillin; Cis-3-Hexenyl Acetate; Diphenyl Oxyde; Ionone Alpha; and mixture thereof.

The inventors have surprisingly discovered it could be particularly effective in the composition of the invention to use a perfume composition comprising perfume raw material selected as disclosed in the two previous paragraphs. They have found that the use of such perfume raw materials could make it unnecessary to use a cationic surfactant in order to limit the malodour development on damp fabric.

Dimethyl cyclohexenyl 3-butenyl ketone is available under the name Neobutenone Alpha®, Galbascone®, Dynascone® or galbanum Ketone®. 3a,4,5,6,7,7a-hexahydro-4,7-methano-1H-indenyl acetate is also known as Flor Acetate or Cyclacet®. Octanal is also known as Octyl Aldehyde. Cis-3 hexen-1-ol is also known as Beta Gamma Hexenol. Nonanal is also known as Nonyl Aldehyde. (Z,E)-2,4-dimethyl cyclohex-3-ene-1-carbaldehyde is also known as Ligustral® or Triplal® or Cyclal®. Tetrahydro-4-methyl-2-(2-methyl propenyl)-2H-pyran is also known as Rose Oxide. Iso propylbutanal is also known as Florhydral®. 2-pentylcyclopentan-1-ol is also known as Cyclopentol®. Dodecenal is also known as Lauric Aldehyde. D-limonene is also known as Orange Terpenes. Allyl Caproate is also known as allyl hexanoate. Decenal is also known as Decyl Aldehyde. (E)-1-trimethyl-1-cyclohex-3(2,6,6-enyl)but-2-en-1-one is also known as Delta Damascone. 2,4,6-trimethyl-3-cyclohexene-1-carboxaldehyde is also known as Cyclo Citral. 3-(4-tert-butylphenyl)propanal is also known as Bourgeonal®. Prop-2-enyl 2-cyclohexyloxyacetate is also known as Cyclo Galbanate®. 2-pentyl-Cyclopentanone is also known as Delphone®. Ethyl-2-methyl Pentanoate is also known as Manzanate®. [(4Z)-1-cyclooct-4-enyl]methyl carbonate is also known as Violiff®. 2-methoxyethylbenzene is also known as Keone or Pandanol. 2-tert-butyl cyclohexyl acetate is also known as Verdox. 3alpha,4,5,6,7,7alpha-hexahydro-4,7-methano-1H-inden-6-yl propanoate is also known as Cyclaprop or Frutene. Iso-bornyl iso-butyrate is also known as Abierate®.

The composition may comprise one or more perfume delivery systems. The perfume delivery system may comprise neat perfume, perfume microcapsules, pro-perfumes, polymer particles, functionalized silicones, polymer assisted delivery, molecule assisted delivery, fiber assisted delivery, amine assisted delivery, cyclodextrins, starch encapsulated accord, zeolite and inorganic carrier, and mixtures thereof. Perfume delivery technologies, methods of making certain perfume delivery technologies and the uses of such perfume delivery technologies are disclosed in US 2007/0275866 A1, US 2004/0110648 A1, US 2004/0092414 A1, 2004/0091445 A1, 2004/0087476 A1, U.S. Pat. Nos. 6,531,444, 6,024,943, 6,042,792, 6,051,540, 4,540,721, and 4,973,422.

To fight the malodour associated with damp fabric, it may be particularly effective that the perfume delivery system comprises neat perfume or starch encapsulated accord. The composition may comprise from 0.01% to 10%, or from 0.1% to 5%, or even from 0.2% to 2% by weight of neat perfume. The composition may comprise from 0.01% to 10%, or from 0.1% to 5%, or even from 0.2% to 2% by weight of starch encapsulated accord.

The composition may comprise a perfume microcapsule. The perfume microcapsules may provide longer freshness to the fabric. The composition may comprise from 0.01% to 10%, or from 0.1% to 5%, or even from 0.2% to 2% by weight of a perfume microcapsule.

The perfume microcapsule may comprise an aminoplast material, polyamide material and/or an acrylate material, for example a melamine-formaldehyde or ureaformaldehyde material. The perfume microcapsule may comprise a cationic, nonionic and/or anionic deposition aid. The perfume microcapsule may comprise a deposition aid selected from the group consisting of, a cationic polymer, a nonionic polymer, an anionic polymer and mixtures thereof. The perfume microcapsule may comprise a cationic polymer. The perfume microcapsule may comprise a moisture-activated microcapsule (e.g., cyclodextrin comprising perfume microcapsule).

### Rheological Modifier

Preferably, the composition comprises from 0.01% to 10%, from 0.05 to 5%, or from 0.15% to 3% by weight of a rheological modifier. Suitable rheological modifiers are disclosed in, for example, U.S. patent application Ser. No. 12/080,358.

The rheological modifier may be a cationic or amphoteric polymer. The rheological modifier may be a cationic polymer. The cationic polymer may comprise a cationic acrylate such as Rheovis CDE™. The cationic polymer may have a cationic charge density of from about 0.005 to about 23, from about 0.01 to about 12, or from about 0.1 to about 7 milliequivalents/g, at the pH of intended use of the composition. For amine-containing polymers, wherein the charge density depends on the pH of the composition, charge density is measured at the intended use pH of the product. Such pH will generally range from about 2 to about 11, more generally from about 2.5 to about 9.5. Charge density is calculated by dividing the number of net charges per repeating unit by the molecular weight of the repeating unit. The positive charges may be located on the backbone of the polymers and/or the side chains of polymers.

One group of suitable cationic polymers includes those produced by polymerization of ethylenically unsaturated monomers using a suitable initiator or catalyst, such as those disclosed in U.S. Pat. No. 6,642,200.

Suitable polymers may be selected from the group consisting of cationic or amphoteric polysaccharide, polyethylene imine and its derivatives, and a synthetic polymer made by polymerizing one or more cationic monomers selected from the group consisting of N,N-dialkylaminoalkyl acrylate, N,N-dialkylaminoalkyl methacrylate, N,N-dialkylaminoalkyl acrylamide, N,N-dialkylaminoalkylmethacrylamide, quaternized N,N dialkylaminoalkyl acrylate quaternized N,N-dialkylaminoalkyl methacrylate, quaternized N,N-dialkylaminoalkyl acrylamide, quaternized N,N-dialkylaminoalkylmethacrylamide, Methacryloamidopropyl-pentamethyl-1,3-propylene-2-ol-ammonium dichloride, N,N,N,N′,N′,N″,N″-heptamethyl-N″-3-(1-oxo-2-methyl-2-propenyl)aminopropyl-9-oxo-8-azo-decane-1,4,10-triammonium trichloride, vinylamine and its derivatives, allylamine and its derivatives, vinyl imidazole, quaternized vinyl imidazole and diallyl dialkyl ammonium chloride and combinations thereof, and optionally a second monomer selected from the group consisting of acrylamide, N,N-dialkyl acrylamide, methacrylamide, N,N-dialkylmethacrylamide, C₁-C₁₂ alkyl acrylate, C₁-C₁₂ hydroxyalkyl acrylate, polyalkylene glyol acrylate, C₁-C₁₂ alkyl methacrylate, C₁-C₁₂ hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and derivatives, acrylic acid, methacrylic acid, maleic acid, vinyl sulfonic acid, styrene sulfonic acid, acrylamidopropylmethane sulfonic acid (AMPS) and their salts. The polymer may optionally be branched or cross-linked by using branching and crosslinking monomers. Branching and crosslinking monomers include ethylene glycoldiacrylate divinylbenzene, and butadiene. A suitable polyethyleneinine useful herein is that sold under the tradename Lupasol® by BASF, AG, Lugwigschaefen, Germany

The aqueous fabric care composition may comprise an amphoteric rheological modifier polymer. The polymer preferably possesses a net positive charge. Said polymer may have a cationic charge density of about 0.05 to about 18 milliequivalents/g.

The rheological modifier may be selected from the group consisting of cationic polysaccharide, polyethylene imine and its derivatives, poly(acrylamide-co-diallyldimethylammonium chloride), poly(acrylamide-methacrylamidopropyltrimethyl ammonium chloride), poly(acrylamide-co-N,N-dimethyl aminoethyl acrylate) and its quaternized derivatives, poly(acrylamide-co-N,N-dimethyl aminoethyl methacrylate) and its quaternized derivative, poly(hydroxyethylacrylate-co-dimethyl aminoethyl methacrylate), poly(hydroxpropylacrylate-co-dimethyl aminoethyl methacrylate), poly(hydroxpropylacrylate-co-methacrylamidopropyltrimethylammonium chloride), poly(acrylamide-co-diallyldimethylammonium chloride-co-acrylic acid), poly(acrylamide-methacrylamidopropyltrimethyl ammonium chloride-co-acrylic acid), poly(diallyldimethyl ammonium chloride), poly(vinylpyrrolidone-co-dimethylaminoethyl methacrylate), poly(ethyl methacrylate-co-quaternized dimethylaminoethyl methacrylate), poly(ethyl methacrylate-co-oleyl methacrylate-co-diethylaminoethyl methacrylate), poly(diallyldimethylammonium chloride-co-acrylic acid), poly(vinyl pyrrolidone-co-quaternized vinyl imidazole) and poly(acrylamide-co-Methacryloamidopropyl-pentamethyl-1,3-propylene-2-ol-ammonium dichloride), Suitable rheological modifiers include Polyquaternium-1, Polyquaternium-5, Polyquaternium-6, Polyquaternium-7, Polyquaternium-8, Polyquaternium-11, Polyquaternium-14, Polyquaternium-22, Polyquaternium-28, Polyquaternium-30, Polyquaternium-32 and Polyquaternium-33, as named under the International Nomenclature for Cosmetic Ingredients.

The rheological modifier may comprise polyethyleneimine or a polyethyleneimine derivative. The rheological modifier may comprise a cationic acrylic based polymer. The rheological modifier may comprise a cationic polyacrylamide. The rheological modifier may comprise a polymer comprising polyacrylamide and polymethacrylamidoproply trimethylammonium cation. The rheological modifier may comprise poly(acrylamide-N-dimethyl aminoethyl acrylate) and its quaternized derivatives. The rheological modifier may be that sold under the tradename Sedipur®, available from BTC Specialty Chemicals, a BASF Group, Florham Park, N.J. The rheological modifier may comprise poly(acrylamide-co-methacrylamidopropyltrimethyl ammonium chloride). The rheological modifier may comprise a non-acrylamide based polymer, such as that sold under the tradename Rheovis® CDE, available from Ciba Specialty Chemicals, a BASF group, Florham Park, N.J., or as disclosed in USPA 2006/0252668.

The rheological modifier may be selected from the group consisting of cationic or amphoteric polysaccharides. The rheological modifier may be selected from the group consisting of cationic and amphoteric cellulose ethers, cationic or amphoteric galactomanan, cationic guar gum, cationic or amphoteric starch, and combinations thereof.

The rheological modifier may be selected from cationic polymers such as alkylamine-epichlorohydrin polymers which are reaction products of amines and oligoamines with epicholorohydrin, for example, those polymers listed in, for example, U.S. Pat. Nos. 6,642,200 and 6,551,986. Examples include dimethylamine-epichlorohydrin-ethylenediamine, available under the trade name Cartafix® CB and Cartafix® TSF from Clariant, Basle, Switzerland.

The rheological modifier may be selected from cationic polymers such as polyamidoamine-epichlorohydrin (PAE) resins of polyalkylenepolyamine with polycarboxylic acid. The most common PAE resins are the condensation products of diethylenetriamine with adipic acid followed by a subsequent reaction with epichlorohydrin. They are available from Hercules Inc. of Wilmington Del. under the trade name Kymene™ or from BASF AG (Ludwigshafen, Germany) under the trade name Luresin™

The cationic polymers may contain charge neutralizing anions such that the overall polymer is neutral under ambient conditions. Non-limiting examples of suitable counter ions (in addition to anionic species generated during use) include chloride, bromide, sulfate, methylsulfate, sulfonate, methylsulfonate, carbonate, bicarbonate, formate, acetate, citrate, nitrate, and mixtures thereof.

The cationic rheological modifier may be obtained by polymerisation of a cationic monomer and a monomer with hydrophobic nature and a non-ionic monomer. In particular, the cationic rheological modifier may be as disclosed in US 2013/090282. The cationic rheological modifier may be supplied by SNF.

The weight-average molecular weight of the polymer may be from about 500 to about 5,000,000, or from about 1,000 to about 2,000,000, or from about 2,500 to about 1,500,000 Daltons, as determined by size exclusion chromatography relative to polyethyleneoxide standards with RI detection. In one aspect, the MW of the cationic polymer may be from about 500 to about 37,500 Daltons.

The aqueous composition has typically a Brookfield viscosity at 60 rpm at 21° C. of higher than 20 cp or 30 cp, for example between 40 cp and 1000 cp or between 80 cp and 500 cp.

Adjunct Ingredients:

The aqueous fabric care composition may comprise adjunct ingredients. The ingredients may include dispersing agent, stabilizer, pH control agent, metal ion control agent, colorant, brightener, dye, odor control agent, pro-perfume, cyclodextrin, solvent, soil release polymer, preservative, additional antimicrobial agent, chlorine scavenger, enzyme, antishrinkage agent, fabric crisping agent, spotting agent, anti-oxidant, anti-corrosion agent, bodying agent, drape and form control agent, smoothness agent, static control agent, wrinkle control agent, sanitization agent, disinfecting agent, germ control agent, mold control agent, mildew control agent, antiviral agent, drying agent, stain resistance agent, soil release agent, malodor control agent, fabric refreshing agent, chlorine bleach odor control agent, dye fixative, dye transfer inhibitor, color maintenance agent, color restoration/rejuvenation agent, anti-fading agent, whiteness enhancer, anti-abrasion agent, wear resistance agent, fabric integrity agent, anti-wear agent, rinse aid, UV protection agent, sun fade inhibitor, insect repellent, anti-allergenic agent, flame retardant, water proofing agent, fabric comfort agent, water conditioning agent, stretch resistance agent, cationic starch, and combinations thereof. Each adjunct ingredient may be present in an amount of for example from 0.01 to 3% by weight of the composition. The aqueous fabric care composition may comprise an antibacterial agent. The composition may be free or essentially free of some or all of the above mentioned adjunct ingredient. The composition may be free or essentially free of phosphate builders, such as sodium tripolyphosphate. The composition may be free or essentially free of gums such as carbomethoxycellulose or succinoglycan polysaccharide.

The composition of the invention may have a pH of from about 2 to about 5, preferably from about 2 to about 4.5, and more preferably from about 2.5 to about 4. In another embodiment, the composition may have a pH from about 5 to about 9, alternatively from 5.1 to about 6, alternatively from about 6 to about 8, alternatively from about 7.

Preferably the aqueous composition does not comprise or comprise a limited amount of fat and compounds that comprise nitrogen.

In one embodiment, the composition of the invention does not comprise, or comprise a low level of nitrogen comprising material, for example from 0 to 5% or from 0 to 3% or from 0 to 1% or from 0 to 0.1% by weight of nitrogen comprising material.

The composition of the invention preferably does not comprise, or comprise a low level of urea comprising material, for example from 0 to 5% or from 0 to 3% or from 0 to 1% or from 0 to 0.1% of urea.

The composition of the invention preferably does not comprise, or comprise a low level of softening oils, which include but are not limited to, vegetable oils (such as soybean, sunflower, and canola), hydrocarbon based oils (natural and synthetic petroleum lubricants, in one aspect polyolefins, isoparaffins, and cyclic paraffins), triolein, fatty esters, fatty alcohols, fatty amines, fatty amides, and fatty ester amines. For example the composition of the invention comprises from 0 to 5% or from 0 to 3% or from 0 to 1% or from 0 to 0.1% by weight of softening oils, triolein, fatty esters, fatty alcohols, fatty amines, fatty amides, and fatty ester amines. For example the composition of the invention comprises from 0 to 5% or from 0 to 3% or from 0 to 1% or from 0 to 0.1% by weight of softening oils. For example the composition of the invention comprises from 0 to 5% or from 0 to 3% or from 0 to 1% or from 0 to 0.1% by weight of fatty alcohols.

The composition of the invention may comprise from 0 to 5% or from 0 to 3% or from 0 to 1% or from 0 to 0.1% by weight of clay.

The composition of the invention may comprise from 0 to 5% or from 0 to 3% or from 0 to 1% or from 0 to 0.1% by weight of glycerol and/or polyglycerol ester.

The composition of the invention preferably does not comprise amines, or comprise a low level of amine, for example from 0 to 5% or from 0 to 3% or from 0 to 1% or from 0 to 0.1% by weight of amines. Amines include but are not limited to, materials selected from the group consisting of esteramines, amidoamines, imidazoline amines, alkyl amines, amdioester amines and mixtures thereof. Ester amines include but are not limited to, materials selected from the group consisting of monoester amines, diester amines, triester amines and mixtures thereof.

The invention also concerned the use of a composition of the invention to rinse or treat a fabric. In one embodiment, the invention concerns a process to clean and rinse a fabric comprising the steps of:
cleaning a fabric with a wash liquor comprising an anionic surfactant,
rinsing the cleaned fabric with an aqueous liquor comprising the aqueous fabric care composition of the invention.

The process of the invention may be used in an automatic laundry machine or hand washing laundry basin(s). The process is particularly suitable to be used in a hand washing process. See e.g., U.S. Pat. Appl. No. 2003-0060390 A1. The cleaning step and the rinsing step may happen in the same bath, i.e. the aqueous fabric care composition is added to the wash liquor. Typically, the cleaning step and the rinsing step happen in two different baths. The fabric is removed from the wash liquor and introduced either in water into which is then added the aqueous fabric care composition or to another bath comprising an aqueous liquor comprising water and the aqueous fabric care composition.

The composition of the invention may allow to reduce the volume of water consumed in a rinse process.

### EXAMPLES

### Example 1

### Aqueous Fabric Care Compositions

| | Weight percent of the composition | | | | | | |
|---|---|---|---|---|---|---|---|
| Ingredient | Ex 1A | Ex 1B* | Ex 1C | Ex 1D | Ex 1E | Ex 1F | Ex 1G |
| Free Perfume | 2 | 2 | 1 | 3 | 5 | 0.5 | 2.5 |
| Rheological modifier | 0.2 | 0.2 | 0.5 | 0.1 | 0.1 | 0.5 | 0.2 |
| Suds suppressor | 0.3 | 0.3 | 0.1 | 0.2 | 1.5 | 0.3 | 0.8 |
| technology | | | | | | | |
| (PDMS/silica mixture) | | | | | | | |
| Non ionic surfactant | 0.75 | 0.75 | 0.5 | 0.9 | 3 | 0.75 | 0.25 |
| (EMPILAN | | | | | | | |
| KM80/PW ®) | | | | | | | |
| Non ionic surfactant | 0.1 | 0.1 | 0.2 | 0.05 | | | |
| (Tween 20 ®) | | | | | | | |
| Antibacterial compound | | | | | | 0.01 | |
| Perfume microcapsules | | | | | 0.3 | | |
| Cationic Surfactant | | 5 | | | | | |
| (DEEDMAC) | | | | | | | |
| minors (dye, pH | balance | balance | balance | balance | balance | balance | balance |
| regulator, preservatives, | | | | | | | |
| chelant . . . ) and water | | | | | | | |

*Comparative Example

The compositions are prepared by mixing the ingredients in water at room temperature.

### Example 2

### Evaporation of Sweat from Fabrics Rinsed with Compositions 1A and 1B

Two knitted fabrics of 37 cm×41 cm which have been washed with a composition comprising anionic surfactant are added in a beaker with 8 g of the aqueous fabric care composition of either example 1A or example 1B in 1 l of regular tap water. The fabrics are rinsed during 5 minutes in the beaker. The fabrics are spun dry by using a spin cycle in an automatic washing machine. After spinning, the fabrics are hung to dry. Pieces of 9×6 cm of the dry fabric are cut out.

A drop of 2 grams of a 4% NaCl solution is placed in the centre of the bottom of a plastic cup. The Salty water mimics the saline conditions of sweat.

The pieces of fabric are put on top of the salty water.

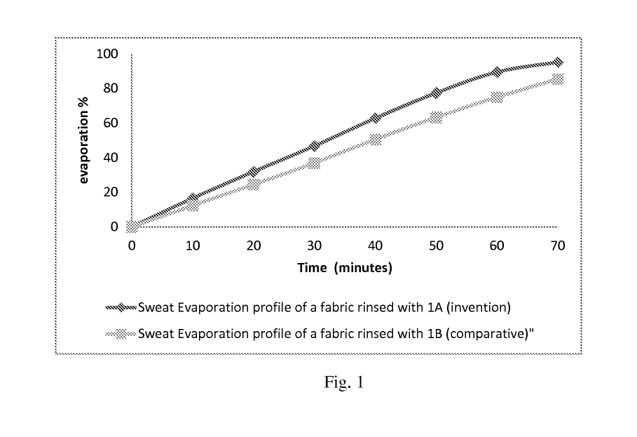

The evaporation at 35° C. is recorded over time and expressed as % evaporation. The test is run in duplicate for composition 1A and in duplicate for composition 1B. FIG. 1 shows the average evaporation from the two experiments.

The sweat evaporates more slowly from the fabric rinsed with composition 1B than from the fabric rinsed with the composition 1A. Thus the sweat would be faster escaping away from the body through a fabric that was treated with a composition according to the invention, leading to a more pleasant in wear feeling and less visual sign of sweating.

### Example 3

### Measurement of the Sweat Smell of Fabrics Rinsed with Compositions 1A and 1B

Two knitted fabrics of 37 cm×41 cm which have been washed with a composition comprising anionic surfactant are added in a beaker with 8 g of the aqueous fabric care composition of either example 1A or example 1B in 11 of regular tap water.

The fabrics are rinsed during 5 minutes in the beaker. The fabrics are spun dry by using a spin cycle in an automatic washing machine. After spinning, the fabrics are hung to dry. Circular pieces of 3 g are cut out of the dry fabrics.

2 grams of a 0.1% isovaleric acid solution are put in a convex glass. The circular pieces of fabric are put on top of the isovaleric acid solution. Isovaleric acid was used to represent one of the unpleasant smelling components present in sweat. The fabrics are left in the glass at room temperature for 143 min.

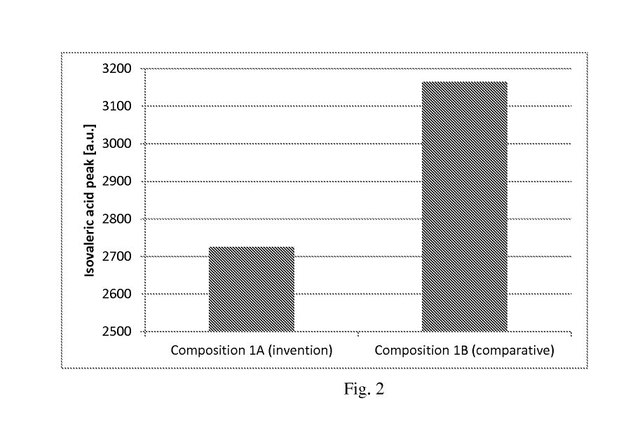

The fabrics impregnated with isovaleric acid are put in glass jars. The headspace in the glass jar is equilibrated during 3 hrs. Next, the headspace was sampled using a 7100 Fast GC Analyzer with a sampling time of 10 seconds and a sensor temperature of 40° C. The peak corresponding to isovaleric acid is determined on a solution of isovaleric acid in water. The isovaleric acid headspace concentration is quantified in both jars as shown in FIG. 2. The isovaleric acid headspace is lower for the fabric rinsed with the composition 1A than for the fabric rinsed with composition 1B.

The sweat malodor has escaped faster from a fabric treated with composition 1A than composition 1B. Fabrics rinsed with a composition according to the invention are not carrying a sweat smell as strong as the fabrics rinsed with composition 1B.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An aqueous fabric care composition comprising:
a) from about 0 wt % to about 5 wt % of anionic surfactant,
b) from about 0 wt % to about 3 wt % of cationic surfactant,
c) from about 0.05 wt % to about 3 wt % of a non-ionic surfactant,
d) from about 0.01 wt % to about 15 wt % of a suds suppressor technology,
e) perfume.

2. The aqueous fabric care composition according to claim 1, wherein the composition comprises from about 0 wt % to about 1.5 wt % of anionic surfactant, from about 0 wt % to about 1.5 wt % of cationic surfactant, from about 0.1 wt % to about 2 wt % of a non-ionic surfactant, from about 0.02 wt % to about 2 wt % of a suds suppressor technology comprising a polymeric silicone, and from about 50 wt % to about 97 wt % of water.

3. The aqueous fabric care composition according to claim 1, wherein the weight ratio of (Cationic surfactant+Anionic surfactant+Non-ionic surfactant) to (Non-ionic surfactant) is below about 2:1.

4. The aqueous fabric care composition according to claim 1, wherein the perfume comprises a mixture of at least 3 perfume raw materials and said perfume comprising at least about 60 wt % of perfume raw material selected from: Lavandin Grosso oil; Iso Propyl-2-Methyl Butyrate; Dimethyl cyclohexenyl 3-butenyl ketone; Eucalyptol; Benzyl Acetate; Hexyl Acetate; Methyl Benzoate; 3a,4,5,6,7,7a-hexahydro-4,7-methano-1H-indenyl acetate; Octanal; Cis-3 hexen-1-ol; Nonanal; Ethyl-2-methyl Butyrate; (Z,E)-2,4-dimethyl cyclohex-3-ene-1-carbaldehyde, Tetrahydro-4-methyl-2-(2-methyl propenyl)-2H-pyran; Geraniol; Iso propylbutanal; 2-pentylcyclopentan-1-ol; Dodecenal; d-limonene; Allyl Caproate; Decenal; Tetra Hydro Linalool; (E)-1-trimethyl-1-cyclohex-3 (2,6,6-enyl)but-2-en-1-one; 2,4,6-trimethyl-3-cyclohexene-1-carboxaldehyde; Ionone Beta; Prenyl Acetate; 3-(4-tert-butylphenyl)propanal; 1 Carvone; Allyl Cyclohexyl Propionate; Linalool; Phenyl ethyl alcohol; Lemon Oil; Eugenol; Ethyl Vanillin; Cis-3-Hexenyl Acetate; Diphenyl Oxyde; Ionone Alpha; prop-2-enyl 2-cyclohexyloxyacetate; 2-pentyl-Cyclopentanone; Ethyl-2-methyl Pentanoate; [(4Z)-1-cyclooct-4-enyl]methyl carbonate; Cedryl Acetate; Cinnamic Alcohol; 2-methoxyethylbenzene; Phenyl Ethyl Phenyl Acetate; Citronellol; 2-tert-butyl cyclohexyl acetate; Citral; 3alpha,4,5,6,7,7alpha-hexahydro-4,7-methano-1H-inden-6-yl propanoate; Iso-bornyl iso-butyrate; and mixtures thereof.

5. The aqueous fabric care composition according to claim 1, wherein the composition comprises a rheological modifier.

6. The aqueous fabric care composition according to claim 1, wherein the composition comprises an antibacterial agent.

7. The aqueous fabric care composition according to claim 1, wherein the weight ratio of (Suds suppressor technology) to (Non-ionic surfactant) is between about 0.1:1 and about 2:1.

8. A package comprising the aqueous fabric care composition according to claim 1, wherein the package is a bottle or a sachet.

9. A process to clean and rinse a fabric comprising the steps of:
a) Cleaning a fabric with a composition comprising an anionic surfactant,
b) Rinsing the cleaned fabric with an aqueous liquor comprising the aqueous fabric care composition of claim 1.
